(19) United States
(12) Patent Application Publication
(10) Pub. No.: US 2022/0156337 A1
(43) Pub. Date: May 19, 2022

(54) LATE BINDING DATA FOR LOCATION-BASED SEARCHING

(71) Applicant: HERE Global B.V., Eindhoven (NL)

(72) Inventor: Gregory Ssi-Yan-Kai, Zurich (CH)

(21) Appl. No.: 17/097,833

(22) Filed: Nov. 13, 2020

(51) Int. Cl. G06F 16/9537; G06F 16/2457; G06F 16/9538

(52) U.S. Cl. CPC G06F 16/9537; G06F 16/9538; G06F 16/24578

(57) ABSTRACT

System and methods are provided for generating search results with user created data sets. A location-based query is received. Candidates from a primary datastore and from the user created data sets are identified and merged. The merged candidates are ranked based on a relevancy to the location-based query with priority given to feature data from the user created data set. The ranked results are returned.

### FIELD

The following disclosure relates to navigation devices or services.

### BACKGROUND

Location-based services provide information to individuals based on a geographic location, typically through wireless communication networks and clients such as portable computers, personal digital assistants, mobile phones, and in-vehicle navigation systems. Some of the most common applications for location-based services include local news, directions, points of interest, directory assistance, fleet management, emergency, asset tracking, location-sensitive building, and local advertisement among others. These highly specialized services traditionally require handcrafted data, algorithms, APIs, and infrastructure.

Location-based services use an engine that understands complex relationships among locations, people and assets and provides effective ways to accurately pinpoint them on the map. In an example, a location-based service might include hyper-precise point addresses while enabling display of roof-top and navigable positions. One application for location-based services is location-based searching. Location-based searching includes a reference location in a query that limits the results to a geographic region. A location-based search service may use full, partial, or structured input, and utilize an advanced matching algorithm to assure what is entered accurately matches the map. The local based search and discovery may be provided using simple input text to search. Information such as the name and the type of a point of interest (POI), whether it is a coffee shop or post office, for example is quickly provided, as well as a variety of ways to interact with it. The service also gives access to autosuggest functionality to provide fast suggestions as the user types for places, addresses, chain queries or category queries. Searching for either addresses or POIs/Places is also supported even when the address is incomplete. While these services are currently sufficient, the development of conversational systems and big data has changed user expectations, particularly around search. A large volume of data—both structured and unstructured—is collected on a day to day basis. This data includes larger, more varied, and more complex data sets, especially from new data sources. Searches now need to combine these varied data sources to return information-rich results in a consistent format.

### SUMMARY

In an embodiment, a method is provided for late binding of external data for location-based searching. The method includes receiving, by a processor, a location-based query; searching, by the processor, a primary datastore for one or more first candidates for the location-based query; acquiring, by the processor from a secondary datastore, one or more second candidates for the location-based query including feature data for the one or more second candidates; merging, by the processor, the one or more first candidates and the one or more second candidates; ranking, by the processor, the merged candidates based on relevancy to the location-based query, wherein the ranking gives priority to the feature data included with the one or more second candidates; and providing, by the processor, the ranked merged candidates.

In an embodiment, a system is provided for late binding of external data for location-based searching. The system includes a user interface, a primary datastore, at least one secondary datastore, a candidate generator, and a search controller. The user interface is configured to receive a location-based query. The primary datastore is configured to store location related data. The at least one secondary datastore is configured to store location related data comprising at least one point of interest not contained in the primary datastore. The candidate generator is configured to receive the location-based query and search the primary datastore for one or more first candidates for the location-based query. The search controller is configured to merge the one or more first candidates with one or more second candidates acquired from the secondary datastore, to rank the merged candidates, and provide the ranked merged candidates to the user interface.

In an embodiment, an apparatus is provided including at least one processor and at least one memory including computer program code for one or more programs. The at least one memory is configured to store the computer program code that is configured to, with the at least one processor, cause the at least one processor to: receive a location-based query; search a primary datastore for one or more first candidates for the location-based query; acquire from a secondary datastore one or more second candidates for the location-based query including feature data for the one or more second candidates; merge the one or more first candidates and the one or more second candidates; rank the merged candidates based on relevancy to the location-based query, wherein the ranking gives priority to the feature data included with the one or more second candidates; and provide the ranked merged candidates.

### BRIEF DESCRIPTION OF THE DRAWINGS

Exemplary embodiments of the present invention are described herein with reference to the following drawings.

FIG. 1 depicts an example system for location-based searching according to an embodiment.

FIG. 2 depicts an example server of the system of FIG. 1 according to an embodiment.

FIG. 3 depicts an example workflow for location-based searching with late binding data according to an embodiment.

FIG. 4 depicts an example map of a geographic region.

FIG. 5 depicts an example geographic database of the system of FIG. 1.

FIG. 6 depicts an example structure of segments and nodes in the geographic database.

FIG. 7 depicts an example location graph according to an embodiment.

FIG. 8 depicts an example device of the system of FIG. 1.

FIG. 9 depicts an example vehicle for the device of FIG. 8 according to an embodiment.

### DETAILED DESCRIPTION

Embodiments described herein provide systems and methods for generating search results with user created data sets. A location-based query is received. Candidates from a primary datastore and from the user created data sets are identified and merged. The merged candidates are ranked based on a relevancy to the location-based query with priority given to feature data from the user created data set. The ranked results are returned.

A search engine typically includes at least two main things: a database of information, and algorithms that compute which results to return and rank for a given query.

Search engines typically store the information in an index, a large database with an entry for each possible candidate. Indexing is the process by which search engines organize information before a search to enable fast responses to queries. Without an index, a search engine might have to scan every document, which would require considerable time and computing power. For example, while an index of 5,000 documents can be queried within milliseconds, a sequential scan of every word in 5,000 large documents could take hours. The additional computer storage required to store the index, as well as the considerable increase in the time required for an update to take place, are traded off for the time saved during information retrieval.

One drawback to indexing is that a search may only be performed on specific data that has been processed, indexed, and stored in the specific datastore. A user may desire to bring their own proprietary and curated datasets to the search engine to leverage the quality and processing power of the search engine. Users may also desire to take advantage of the extensive geographic database maintained by the search engine. For example, a user may use the searching platform to add an intake channel for customized or personal points of interest or to query customized or personal points of interests, or retrieve personal or proprietary points of interests by name, category, location, and any other custom attribute. Data that might be useful for niche purposes may not be included in an index as additional data may slow down typical searches as the time to search is directly proportional the amount of data that must be searched. Additionally, a user or organization may additionally create data sets to store proprietary data that is not publicly available. The user or organization may still desire to use this data in location-based searching even while keeping the data private. Current search engines are configured to provide candidates for location-based queries but not with customized information that a user or organization wants. If a user or organization wants to use the search engine with a custom dataset, they have to go through a data ingestion process.

Data ingestion is the process of transporting or importing data from assorted sources to a storage medium where it can be accessed, used, and analyzed. The destination is typically a data warehouse, data mart, database, or a document store. Sources may be almost anything—including SaaS data, in-house apps, databases, spreadsheets, or even information scraped from the internet. To make better decisions and provide better service, users and organizations need access to all of their data sources in a timely manner. An incomplete picture of available data can result in a subpar experience. As an example of the integration process for location related data, Users must become a partner with the developer of the search engine. Once the user or the organization has credentials, they can create a catalog for the data that they want to publish or use. User POIs are ingested in an open location platform (OLP) pipeline self-service. Users then contact a project manager at the developer to provide required information such as OLP layer Here Resource Name (HRN), app id, estimated dataset volume, expected refresh rate. Users then wait for confirmation that their POI have been indexed and are available for use in the searching application. The ingestion process is not efficient and has several drawbacks. Users are required to wait for data to be ingested. Processing of the data is done at multiple locations and includes multiple points of failure. There is a need for an ability to access and apply data from external sources without sacrificing speed or accuracy of the search engine.

Embodiments provide a location-based search that is configured to integrate user data at run time and therefore skip the normal integration process. Embodiments thus provide where the data storage can stay on external infrastructure and be maintained by the user or organization. Users have to option to host their dataset on sight and with their existing storage, e.g., relational databases like Oracle, S3 buckets, or in-house storage. This removes the requirement to ingest data in OLP and allows organizations or users to quickly acquire, update, and publish data for use in location-based searching. Embodiments provide for a quick and accurate search on indexed data but also allow for custom data to be included in the filtered and ranked results. A query received from a user is executed on the primary datastore to generate identifiers for candidates for the query. An external datastore is identified that is relevant to the search query. The external database may be proprietary or private. The external database may include feature data that is related to custom ranks for results. Candidates from the external database are merged with candidates from the primary datastore. The merged candidates are filtered, ranked, and returned to the user. The ranking of the merged candidates may give priority to candidates or feature data from the external datastore.

Embodiments provide improved location services that are configurable, feedback-based, and that can answer a broader range of questions than the current generation of location services. Embodiments provide an increase in quality, expand location services into new domains, and enable applications that are context and intent aware. In addition, services are provided that offer new capabilities and seamlessly merge different data sources in order to better serve users and provide better search results. Embodiments provide precise and valuable insights on the location of addresses, places, and points of interest (POIs). Embodiments minimize disruptions by incorporating external data into search results to extract more location insights. Embodiments allow for third party datasets or logic to enrich or tailor search experiences to meet specific needs. For example, users or entities may integrate custom or proprietary POI datasets into the search infrastructure in order to provide custom results.

In an example scenario, an automotive OEM creates a dataset that includes information including charging stations that are accessible for their customers. A user may search for “charging station near me.” A typical location-based search may return a list of public charging that are near the user's location. These results, however, do not include the charging stations for the automotive OEM. Embodiments provide a mechanism for the automotive OEM to provide their data to their customers while leveraging the search engine's capabilities. The automotive OEM can monitor their charging stations and provide up to date information that provides better results for their customers when the query “charging station near me” is received. Because the data is maintained by the OEM and bound to the search late in the process, the data may be as fresh as possible. The results (ranking/order) may also be manipulated by the automotive OEM to be tailored specifically for their customers or even a specific customer. The result is higher quality search results.

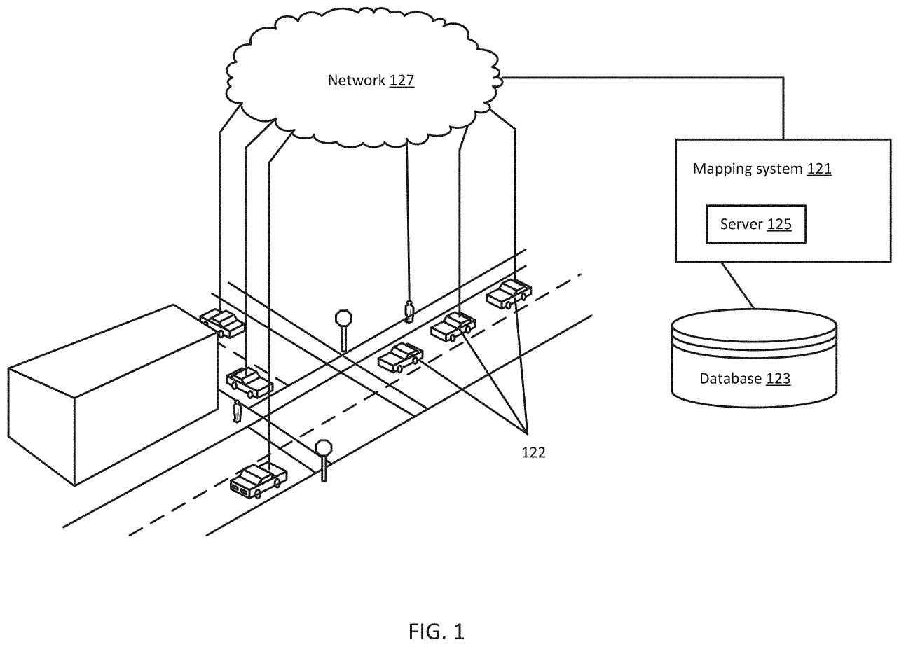

FIG. 1 illustrates an example system for generating search results with user created data sets. The system includes one or more devices 122, a network 127, and a mapping system 121. The mapping system 121 may include a database 123 (also referred to as a geographic database 123 or map database) and a server 125. Additional, different, or fewer components may be included.

The one or more devices 122 may include probe devices, probe sensors, IoT (internet of things) devices, or other devices 122 such as personal navigation devices 122 or connected vehicles. The device 122 may be a mobile device or a tracking device that provides data for the location of a person or vehicle. The devices 122 may include mobile phones running specialized applications that collect location data as the devices 122 are carried by persons or things traveling a roadway system. The devices 122 may include traditionally dumb or non-networked physical devices and everyday objects that have been embedded with one or more sensors or data collection applications and are configured to communicate over a network 127 such as the internet. The devices may be configured as data sources that are configured to acquire roadway data. The devices 122 may be remotely monitored and controlled. The devices 122 may be part of an environment in which each device 122 communicates with other related devices in the environment to automate tasks. The devices may communicate sensor data to users, businesses, and, for example, the mapping system 121.

In an embodiment, a device 122 is configured to generate or provide location-based queries, using for example, an application or a user interface. A location-based query includes a topic and a reference location. The reference location may be based on a location of the device 122, for example using a positioning system, or may be included in the query, for example as in the query “restaurants in Chicago.” Unlike a general web or internet search, a location-based search is expected to find and rank documents or data that are not only related to the query topic but also geographically related to the location which the query is associated with. In addition to the traditional text-based querying, location-based search engines often provide a more user-friendly query interface which uses graphical maps. One difference between general search engines and location-based search engines is that the first group search the web pages collected from the entire World Wide Web; while location-based search engines typically search on a smaller collection that may be referred to as the geographic database 123.

The geographic database 123 is configured to store and provide information to and from at least the mapping system 121, server 125, and devices 122. The geographic database 123 may include one or more indexes of geographic data. The indexes may include various types of indexes that relate the different types of data to each other or that relate to other aspects of the data contained in the geographic database 123. The indexes may include, for example, data relating to points of interest or roadway features. The point of interest data may include point of interest records including, for example, a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The geographic database 123 provides data for a location-based search service. The geographic database 123 may be maintained by a content provider (e.g., a map developer). By way of example, the map developer may collect geographic data to generate and enhance the geographic database 123. The map developer may obtain data from sources, such as businesses, municipalities, or respective geographic authorities. In addition, the map developer may employ field personnel to travel throughout the geographic region to observe features and/or record information about the roadway.

To communicate with the systems or services, for example to and from the devices 122, the server 125 and geographic database 123 are connected to the network 127. The server 125 may receive or transmit data through the network 127. The server 125 may also transmit paths, routes, or loss of traction risk data through the network 127. The server 125 may also be connected to an OEM cloud. Mapping and location-based services may be provided to vehicles via the OEM cloud or directly by the server 125 or mapping system 121. The network 127 may include wired networks, wireless networks, or combinations thereof. The wireless network may be a cellular telephone network, LTE (Long-Term Evolution), 4G LTE, a wireless local area network, such as an 802.11, 802.16, 802.20, WiMAX (Worldwide Interoperability for Microwave Access) network, DSRC (otherwise known as WAVE, ITS-G5, or 802.11p and future generations thereof), a 5G wireless network, or wireless short-range network such as Zigbee, Bluetooth Low Energy, Z-Wave, RFID and NFC. Further, the network 127 may be a public network, such as the Internet, a private network, such as an intranet, or combinations thereof, and may utilize a variety of networking protocols now available or later developed including, but not limited to transmission control protocol/internet protocol (TCP/IP) based networking protocols. The devices 122 may use Vehicle-to-vehicle (V2V) communication to wirelessly exchange information with other devices 122 or the mapping system 121. The devices 122 may use V2V communication to broadcast and receive omni-directional messages creating a 360-degree “awareness” of other vehicles in proximity of the vehicle. Vehicles equipped with appropriate software may use the messages from surrounding vehicles to determine potential threats or obstacles as the threats develop. The devices 122 may use a V2V communication system such as a Vehicular ad-hoc Network (VANET).

The mapping system 121 includes at least one server 125. The server 125 may be a host for a website or web service such as a location-based search service, mapping service, and/or a navigation service. The mapping service may provide standard maps or high definition (HD) maps generated from the geographic data of the database 123, and the navigation service may generate routing or other directions from the geographic data of the database 123. The server 125 is also configured to provide a location-based search service. The server 125 is configured to query the geographic database 123 in response to a query received from a device 122 or through a search interface. The server 125 is configured to merge the results from the geographic database 123 with results provided by or acquired from a secondary datastore that includes at least one entity or POI that is not contained in the geographic database 123. For example, the server 125 may be configured to receive a query about points of interests near a location. The server 125 is configured to identify possible candidate points of interest that satisfy the query and the locational requirements. These results are merged with candidate points of interest that are stored in a user created dataset. The merged candidates are then filtered, ranked, and provided to a device 122, application, or person that initiated the query.

The mapping service may also provide information generated from attribute data included in the database 123. The server 125 may also provide historical, future, recent or current traffic conditions for the links, segments, paths, or routes using historical, recent, or real time collected data. The server 125 is configured to communicate with the devices 122 through the network 127. The server 125 is configured to receive a request from a device 122 for a route or maneuver instructions and generate one or more potential routes or instructions using data stored in the geographic database 123. The server 125 may also be configured to provide up to date information and maps to external geographic databases or mapping applications. The server 125 may also be configured to generate routes or paths between two points (nodes) on a stored map. The server 125 may be configured to encode or decode map or geographic data. An HD map and the geographic database 123 may be maintained and updated by the server 125 and/or mapping system 121. The mapping system 121 may include multiple servers 125, workstations, databases, and other machines connected together and maintained by a map developer. The mapping system 121 may be configured to acquire and process data relating to roadway or vehicle conditions. For example, the mapping system 121 may receive and input data such as vehicle data, user data, weather data, road condition data, road works data, traffic feeds, etc. The data may be historical, real-time, or predictive. The data may be stored in an HD map, in a location graph, or in the geographic database 123 for use in location-based services such as the location-based search service.

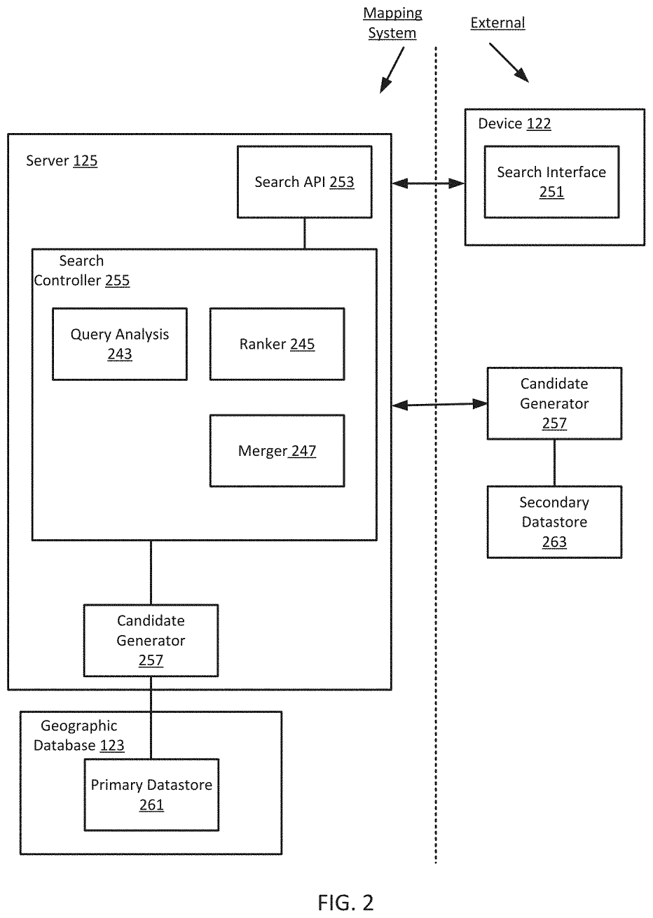

FIG. 2 depicts an example system that is configured for generating search results with user created data sets. FIG. 2 includes a device 122 that includes a search interface 251, a server 125 that includes a search API 253, a search controller 255, and a candidate generator 257, a geographic database 123 that includes a primary datastore 261, and a secondary datastore 263. The server 125 communicates with the at least a search interface 251 (e.g. device 122), the primary datastore 261 (e.g. geographic database 123), and at least one secondary datastore 263 (through a second candidate generator 257). Additional, different, or fewer components may be included. The server is configured to identify and incorporate additional information in enriched search results.

The search API 253 is configured to interact with a search interface 251 or application and communicate a query and results to and from the search controller 255. The search API 253 defines the kinds of calls or requests that can be made, how to make them, the data formats that should be used, the conventions to follow, etc.

The search controller 255 includes several different applications or modules that are configured to process queries, candidates, or results. The search controller 255 includes at least a query analysis application 243, a merger application 247, and a ranking application 245. The query analysis 243 is configured to analysis and interpret the query. The query analysis 243 may be configured to perform country detection, sequence labelling (i.e. tagging), spell correction, misspell term generation, name variant generation, normalization, and/or tokenization among other features.

The search controller 255 is configured to pass the query to one or more candidate generators 257. The candidate generators 257 may be co-located with the search controller 255, integrated with the search controller 255, deployed in the cloud, or deployed externally with a secondary datastore 263. As depicted in FIG. 2 there is a candidate generator 257 for the primary datastore, e.g. geographic database 123 and a candidate generator 257 that is deployed offsite with the secondary datastore 263. In an embodiment, a candidate generator 257 for the secondary datastore 263 may be co-located with the search controller 255. In such a scenario, the internal candidate generator 257 communicates with the secondary datastore 263 over the network. The candidate generators 257 may also be configured to function in the cloud, for example, as a cloud-based application or API that has access to one or more datastores.

The candidate generators 257 are configured to input a query from the search controller 255, search an index/datastore for candidates, and return the candidates to the search controller 255. Each candidate generator 257 may be configured to builds index queries from the search request that may contain free text/textual filters or structured query parameters. The candidate generator 257 queries the index or indices, for example the primary datastore/geographic database 123. The candidate generator 257 constructs the “unresolved” candidate entries, including primarily of their candidate IDs, and certain feature data for the candidates that may be used in the ranking process. The candidates are distilled via numerous filters by the candidate generator 257 in order to return as few candidates as possible. The surviving candidates and certain feature data are returned to the search controller 255.

In an embodiment, a candidate generator 257 for the external datastores uses or is implemented as a cloud-based lambda function. The function may be a cloud computing service that runs code in response to events and automatically manages the computing resources required by that code, e.g., an AWS lambda functionality. Alternatively, the querying is not limited to be bound to a serverless platform. There may be dedicated servers and platforms with well-defined APIs to implement the functionalities required. A responsibility of the cloud-based lambda is to extract POI attributes from a user dataset as expected by the data model of the primary datastore/geographic database 123. For example, each candidate exposed by the lambda function has to have a unique ID, a name, a latitude/longitude position, for example. The use of a cloud-based lambda function means that the operation is serverless, so there is no need to maintain large and complex infrastructure. A cloud-based lambda function also provides granular access which means restrictions can be applied to specific users or roles. A cloud-based lambda function may also be triggered at runtime by other cloud-based services or non-cloud-based services via the cloud-based SDK. Finally, like the data storage, the Lambda function may be configured to run on the customer infrastructure. Enabling users to implement the lambda functions themselves gives them more control over their business logic. For example, an EV automotive OEM can customize the list of EV charging stations depending on the type of vehicle that is making the query.

The search controller 255 is configured to merge candidates from two or more candidate generators 257 using the merger 247. The merging process may use a unique identifier to identify POIs that can be matched. When there is no match, each candidate may be used in the merged set. For candidates that match, e.g. candidates from both sets share an identifier, the data may be merged with data from the secondary datastore 263 taking priority. The merger operation does not affect feature data in the underlying datastore. For example, a candidate from the primary datastore and a candidate from the secondary datastore 263 share an identifier. The merger operation may use feature data for the candidate from the secondary datastore 263 for the search results. The feature data for the candidate from the primary datastore 261 is not updated or changed. In an embodiment, the output of the merger process is a set of candidates including at least one unique POI or candidate from the secondary datastore 263.

The search controller 255 is configured to rank the merged candidates using the ranker 245. Ranking including sorting the candidates according to a criterion so that the “best” results appear early in the result list. Ranking in a search engine is an essential component from a relevance point of view. The objective of a good ranker is to find the best ordering of the documents for a given query and a set of retrieved documents. The search controller 255 is configured to rank candidates based on features data included with the candidates.

The controller may be configured to rank the candidates based on relevancy to the query. Relevance-based ranking means that the retrieved information/points of interest should be relevant to the query topic. For the query “Chicago Hotels” the results must be relevant to the topic i.e. hotel; otherwise, they are irrelevant even though they are related to Chicago. The controller may be configured to rank the results based at least on their distance from the reference location. In the previous example, the hotels in Chicago may be ranked before the hotels in the other cities around Chicago. More specific queries may require more complex ranking. For example, “Chicago hotels with restaurants” may rank results with restaurants higher than those hotels that do not have a restaurant. In addition, hotels that are located in Chicago with higher rated restaurants may be ranked higher.

In an embodiment, the search controller 255 gives more priority to feature data for user created data/POIs in the ranking process. One example may include where the user created dataset includes feature data such as a rating or score metric. This feature data may be prioritized during the ranking/ordering process so that the user created rating is weighted highly in during the ranking process, for example, catapulting one or more POIs (user created or existing in the geographic database 123) above other POIs that otherwise would be ranked or ordered higher. In an example, an organization may wish to promote their own locations or partner locations above POIs in the geographic database 123 by implementing a user created field that ranks or scores POIs with some relationship to the organization. Similarly, the ranking may give priority to user created POIs over existing POIs in the geographic database 123. In an example, an organization may wish to have their user created POIs such as charging stations ranked above publicly available charging stations.

An example workflow for search results with late binding data is presented below. An authorized request comes in via the search API 253. The API 253 performs Service Bundling and Mapping via the support of legacy API Endpoints as well as the OLP API Endpoints. In an embodiment, a search request may include or designate a secondary datastore 263. Alternatively, the search controller 255 may automatically recognize the origin of the search request and automatically include a secondary datastore 263. An Internal Request/Response Message (IRRM), based on the Internal Data Model, is constructed, and handed to the search controller 255. The search controller 255 is configured to process the IRRM from the API. The search controller 255 parses the request (normalization, tokenization etc.), performs query analysis (country detection, sequence labelling/tagging), and performs spell correction and expansion of name variants. The enriched IRRM is then passed on to one or more candidate generators 257. Each candidate generator 257 receives an IRRM from the search controller 255. The candidate generator 257 builds the index queries from the request and queries a respective index. The candidate generator 257 constructs the candidate entries, including candidate IDs. Additional detailed (renderable) information may be retrieved from local or remote storage at a later stage. The candidates are distilled via numerous filters in order to return as few candidates as possible. The surviving candidate IDs are copied to the IRRM and sent back to the search controller 255.

The search controller 255 receives the IRRM with the candidate IDs from the candidate generators 257 and stores the candidates in a temporary storage until all candidate IDs are received. The search controller 255 merges the candidates if more than one candidate generator 257 is used. The storage receives a IRRM from the search controller 255 and resolves candidate IDs in the IRRM to actual address and/or place candidates. The storage enriches the candidate(s) with additional data (e.g. shapes, data base IDs/PVIDs, etc.) if so requested. The candidates are copied to the IRRM and sent back to the Search controller 255.

The search controller 255 receives the IRRM which contains the enriched candidates from the storage. The search controller 255 performs alignments and additional processing. The search controller 255 then ranks/scores the candidates. The search controller 255 selects the appropriate Language Variants and constructs a renderable Address/Place Label. The renderable candidates are copied to the IRRM and returned to the API. The API layer converts an internal representation of resulting candidates to the representation conforming to the requested API endpoint (e.g. SearchAPI response, CDM JSON/XML).

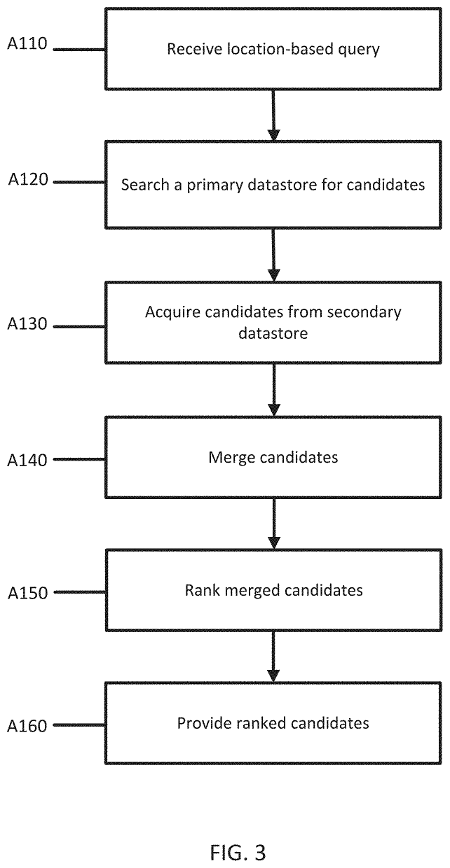

FIG. 3 depicts an example workflow for generating search results with user created data sets using the system of FIG. 2. As presented in the following sections, the acts may be performed using any combination of the components indicated in FIG. 1 or FIG. 2. The following acts may be performed by the server 125, the device 122, the mapping system 121, the search controller 255, the candidate generator 257, or a combination thereof. Additional, different, or fewer acts may be provided. The acts are performed in the order shown or other orders. The acts may also be repeated. Certain acts may be skipped.

At act A110, the search controller 255 receives a location-based query, for example, through the search API 253. The location-based query may include a location reference and one or more subjects. An example location-based query may be “restaurants in Chicago” where Chicago is the location reference and restaurants is the subject. The location reference may be explicit and included in the query, or implicit, for example based off a location of a device 122 that is providing the location-based query. A typical location-based query may request information about point of interests that are near or close to a location. A point of interest (POI) may include any object or reference that also has a location. For example, a hotel, a gas station, a store, a park, a monument, etc. A POI may also include waypoints or other location-based points. Feature data for the POIs may be stored in a geographic database 123 along with a location, for example, the latitude and longitude of each POI. In an embodiment, the location-based query is received from a mobile device 122.

The search controller 255 may include a general processor, digital signal processor, an application specific integrated circuit (ASIC), field programmable gate array (FPGA), analog circuit, digital circuit, combinations thereof, or other now known or later developed processor. The search controller 255 may be a single device or combinations of devices, such as associated with a network, distributed processing, or cloud computing. The search controller 255 is configured to receive the query or search request from the search API 253 and provide search results. The search controller 255 may be configured with query analysis (country detection, sequence labelling (i.e. tagging)), a spelling component (spell correction, misspell term generation), an expander (name variant generation, a normalization module, tokenization), an aligner (scoring & alignment) a ranker (ranking, merging, and cutting), a renderer (language variant selection, address label creation), among other functions and applications. The search controller 255 is configured to pass the formatted and corrected query to one or more candidate generators 257.

At act A120, a candidate generator 257 searches a primary datastore 261 for candidate data for the location-based query. The primary datastore 261 may be or may be included in the geographic database 123. The geographic database 123 is configured to store data that is spatially referenced. The geographic database 123 stores, for example, POI feature data that is related either through location, data structure or type, or common underlying purpose. In an embodiment, the geographic database 123 is configured as a location graph. The location graph is a semantic based graph that stores data with explicit and implicit/derived relationships that may be used to provide additional support for understanding queries and providing quality results. The primary datastore 261 may be searched for each query that is received by the search controller 255.

The search controller 255 and/or the candidate generator 257 are configured to identify one or more indices for which to search on. As described above, the geographic database 123 may include multiple indices that store geographic/location related data. As an example, the search controller 255 may be configured to identify a geographic region or subset of data that the search request relates to. A search may, for example, be related to a city, state, country, etc. The search may be related to a point of interest or another geographic feature. Different types of data may be stores in different indices. The search controller 255 may identify one or more of the indices/datastores that are relevant and thus may include possible candidates for the search request. The search controller 255 may be configured to receive the results of a search of the indices for candidates, merge relevant candidates from different indices, filter the candidates, and rank the candidates. Searching the indices may be performed by the candidate generator 257. The candidate generator 257 is configured to build a query based on the search request, search one or more indices, filter the results, and return candidates to the search controller 255. The indices may be stored/contained in the primary datastore 261.

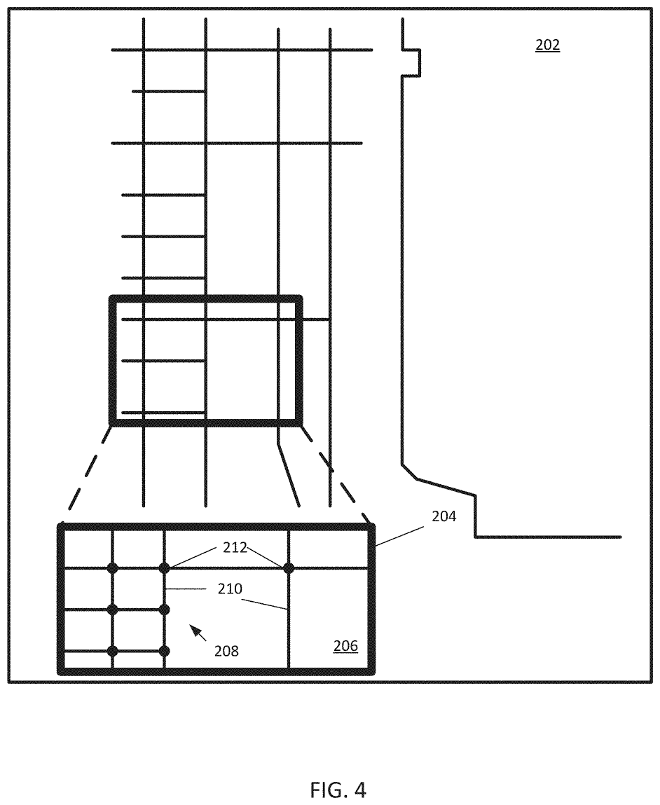

The primary datastore 261 as described herein, refers to a datastore that is available for all searches and is maintained by developers for the mapping system 121. The primary datastore 261 may include or be contained in the geographic database 123. The geographic database 123 includes information about one or more geographic regions. FIG. 4 illustrates a map of a geographic region 202. The geographic region 202 may correspond to a metropolitan or rural area, a state, a country, or combinations thereof, or any other area. Located in the geographic region 202 are physical geographic features, such as roads, points of interest (including businesses, municipal facilities, etc.), lakes, rivers, railroads, municipalities, etc.

FIG. 4 further depicts an enlarged map 204 of a portion 206 of the geographic region 202. The enlarged map 204 illustrates part of a road network 208 in the geographic region 202. The road network 208 includes, among other things, roads and intersections located in the geographic region 202. As shown in the portion 206, each road in the geographic region 202 is composed of one or more road segments 210. A road segment 210 represents a portion of the road. Road segments 210 may also be referred to as links. Each road segment 210 is shown to have associated with it one or more nodes 212; one node represents the point at one end of the road segment and the other node represents the point at the other end of the road segment. The node 212 at either end of a road segment 210 may correspond to a location at which the road meets another road, i.e., an intersection, or where the road dead ends.

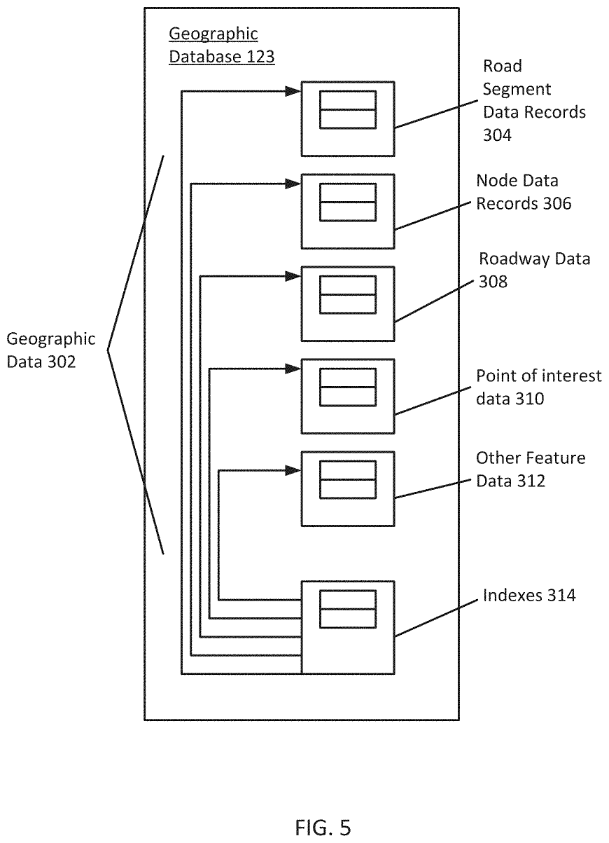

As depicted in FIG. 5, in one embodiment, the geographic database 123 contains geographic data 302 that represents some of the geographic features in the geographic region 202 depicted in FIG. 4. The data 302 contained in the geographic database 123 may include data that represent the road network 208. In FIG. 5, the geographic database 123 that represents the geographic region 202 may contain at least one road segment database record 304 (also referred to as “entity” or “entry”) for each road segment 210 in the geographic region 202. The geographic database 123 that represents the geographic region 202 may also include a node database record 306 (or “entity” or “entry”) for each node 212 in the geographic region 202. The terms “nodes” and “segments” represent only one terminology for describing these physical geographic features, and other terminology for describing these features is intended to be encompassed within the scope of these concepts.

The geographic database 123 may include feature data 308-312. The feature data 312 may represent types of geographic features. For example, the feature data may include roadway data 308 including signage data, lane data, traffic signal data, physical and painted features like dividers, lane divider markings, road edges, center of intersection, stop bars, overpasses, overhead bridges etc. The roadway data 308 may be further stored in sub-indices that account for different types of roads or features. The point of interest data 310 may include data or sub-indices or layers for different types points of interest. The point of interest data may include point of interest records comprising a type (e.g., the type of point of interest, such as restaurant, fuel station, hotel, city hall, police station, historical marker, ATM, golf course, truck stop, vehicle chain-up stations etc.), location of the point of interest, a phone number, hours of operation, etc. The feature data 312 may include other roadway features.

The geographic database 123 also includes indexes 314. The indexes 314 may include various types of indexes that relate the different types of data to each other or that relate to other aspects of the data contained in the geographic database 123. For example, the indexes 314 may relate the nodes in the node data records 306 with the end points of a road segment in the road segment data records 304.

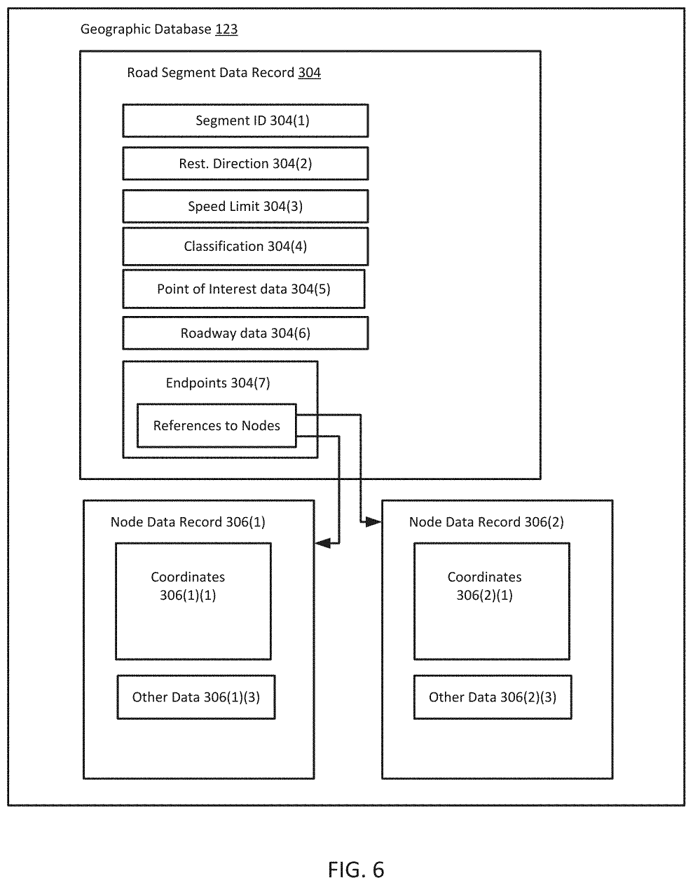

FIG. 6 shows some of the components of a road segment data record 304 contained in the geographic database 123 according to one embodiment. The road segment data record 304 may include a segment ID 304(1) by which the data record can be identified in the geographic database 123. Each road segment data record 304 may have associated with the data record, information such as “attributes”, “fields”, etc. that describes features of the represented road segment. The road segment data record 304 may include data 304(2) that indicate the restrictions, if any, on the direction of vehicular travel permitted on the represented road segment. The road segment data record 304 may include data 304(3) that indicate a speed limit or speed category (i.e., the maximum permitted vehicular speed of travel) on the represented road segment. The road segment data record 304 may also include data 304(4) indicating whether the represented road segment is part of a controlled access road (such as an expressway), a ramp to a controlled access road, a bridge, a tunnel, a toll road, a ferry, and so on. The road segment data record 304 may include data 304(5) related to points of interest. The road segment data record 304 may include data 304(6) that describes lane configurations. The road segment data record 304 also includes data 304(7) providing the geographic coordinates (e.g., the latitude and longitude) of the end points of the represented road segment. In one embodiment, the data 304(7) are references to the node data records 306 that represent the nodes corresponding to the end points of the represented road segment. The road segment data record 304 may also include or be associated with other data 304(7) that refer to various other attributes of the represented road segment such as coordinate data for shape points, POIs, signage, other parts of the road segment, etc. The various attributes associated with a road segment may be included in a single road segment record or may be included in more than one type of record which cross-references to each other. For example, the road segment data record 304 may include data identifying what turn restrictions exist at each of the nodes which correspond to intersections at the ends of the road portion represented by the road segment, the name or names by which the represented road segment is known, the street address ranges along the represented road segment, and so on.

FIG. 6 also shows some of the components of a node data record 306 which may be contained in the geographic database 123. Each of the node data records 306 may have associated information (such as “attributes”, “fields”, etc.) that allows identification of the road segment(s) that connect to it and/or a geographic position (e.g., latitude and longitude coordinates). For the embodiment shown in FIG. 6, the node data records 306(1) and 306(2) include the latitude and longitude coordinates 306(1)(1) and 306(2)(1) for their node. The node data records 306(1) and 306(2) may also include other data 306(1)(3) and 306(2)(3) that refer to various other attributes of the nodes.

The data in in the geographic database 123 may be organized using a graph that specifies relationships between entities. A location graph is a graph that includes relationships between location objects in a variety of ways. Objects and their relationships may be described using a set of labels. Objects may be referred to as “nodes” of the location graph, where the nodes and relationships among nodes may have data attributes. The organization of the location graph may be defined by a data scheme that defines the structure of the data. The organization of the nodes and relationships may be stored in an ontology which defines a set of concepts where the focus is on the meaning and shared understanding. These descriptions permit mapping of concepts from one domain to another. The ontology is modeled in a formal knowledge representation language which supports inferencing and is readily available from both open-source and proprietary tools.

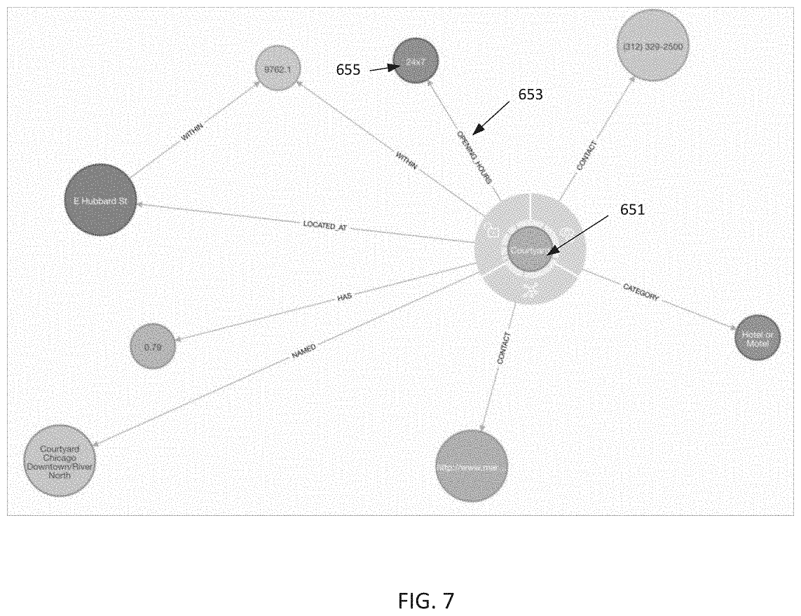

FIG. 7 depicts an example portion of a location graph for the courtyard Chicago downtown hotel. As depicted, the entry for courtyard 651 is related to other nodes by relationships such as the relationship opening_hours 653 and the node 24×7 655. The location graph may be used to assist in providing search results and matching or linking entities between the geographic database 123 and the secondary or user provided dataset. The mapping system 121 may also identify a context for which the location graph is used, and therefore provide appropriate natural guidance accordingly. The natural language guidance may be created by combining a location graph and its ontology. This may be performed, in part, through Natural Language Generation (NLG) algorithms that can produce natural instructions from a digital representation of data. These algorithms may translate graph-based representations into natural languages. Additionally, or alternatively, templates may be used that generate different styles of natural language instructions depending on the use case, context, or problem domain.

A location graph combined with a graph-based natural language generation system may provide location-based search results dynamically and may be dependent upon external factors including context such as time of day, the search requesting entity, or location reference, among others. Additional information may be added to the location graph by users to further enhance the detail and information level provided by the natural guidance. For example, a service technician may visit a building for the first time and may identify where a circuit breaker panel is within the building. This location may be added to the location map as a new location node or bound to an existing location node if that location node corresponds to the location of the circuit breaker panel. In this manner, a subsequent service visit, whether or not it is from the same service technician, may be guided to the circuit breaker panel through natural guidance efficiently and effectively. The location graph described herein may include relationships of various kinds between nodes of the location maps and may use different relationships based on a context of the user. Thus, the location graph is a series of interconnected nodes that are traversed according to the context of a user.

Candidates may be identified by a search algorithm that takes into account a subject of the query and a location reference that is explicitly or implicitly contained in the query. The searching may be performed by the candidate generator 257. The candidate generator 257 is configured to use filters on the data to identify the candidates. These filters may include for example, spatial, textual, semantic etc. filters that filter out entities that are not related to the query. The entities that pass the filter are deemed candidates and passed to the search controller 255 for further processing. The passed candidates may also include feature data from the geographic database 123. The feature data may be used to further filter and/or rank the eventual candidates prior to returning results to the search interface.

Referring back to FIG. 3, at act A130, the search controller 255 acquires one or more second candidates for the location-based query from a secondary datastore 263. The secondary datastore 263 follows the same data model that the primary datastore 261 implements. For the example, the secondary datastore 263 and primary datastore 261 both use a unique identifier for entries/POIs. The one or more second candidates acquired by the search controller 255 may also include feature data provided from the secondary datastore 263. The one or more second candidates may be provided by a candidate generator 257 that is located externally or may be provided by an internal candidate generator 257 that can access the secondary datastore 263. In an embodiment, the candidate generator 257 may be configured as a cloud-based application or process that is provided access to the second datastore and is configured to provide candidates to the search controller 255.

One example of a secondary datastore 263 is a proprietary datastore that contains private information for an organization. As an example, an organization may acquire and store specific information relating to POIs that is used in an application for the organization. In another example, a user may generate a secondary datastore 263 using personal attributes for POIs. The secondary datastore 263 includes at least one POI that is not present/contained in the primary datastore 261/indices/geographic database 123. The secondary datastore 263 may be any type of datastore. In an embodiment, the secondary datastore 263 is a private, proprietary, or personal datastore that is only accessible for certain users/applications. As an example, an organization or individual may provide personal points of interests to assist their uses. Several non-limiting examples are provided below.

A banking organization may use a search with late bound data to provide customers with an application that can show closest ATM belonging to the bank consortium. The banking organization can provide customers an application to search and navigate to ATMs and those of the banks with which the bank is partnered with. The banking organization can restrict the access to banking data to end users having installed the banking application. The bank can thus provide the ATM data to the search platform and be guaranteed that the access to the data is restricted to the banking organization and its application.

An automotive OEM may enable electric vehicles to adapt their routes and integrate an optimal recharging pause. The OEM can provide an in-vehicle-infotainment system that is configured to access a Search API 253 specifically tailored for the purpose of the OEM, hosting both the EV Charging Stations the OEM supports and those from a third-party supplier that the OEM licenses data. The API can guarantee that the data the OEM owns or purchases is only accessible to specific electric vehicles.

A call center contracted for a hotline of a legal insurance company may need to provide personalized yellow pages support about lawyer offices to customers calling the hotline. The call center may wish to inform those customers about nearby lawyer offices with precise legal specialties, names, phone number and addresses. The call center needs to be able to query an updated database containing lawyer's data that the company is willing to maintain in an exclusive platform layer.

A college may desire a private map application. The private map may help students to find any building or department on the campus private map, such as the lecture hall. This data may be only accessible to members of the college.

Similar to internal candidates, the candidates from the secondary datastore 263 may be identified by a search algorithm that takes into account a subject of the query and a location reference that is explicitly or implicitly contained in the query. The searching may be performed by a candidate generator 257. The candidate generator 257 is configured to use filters on the data to identify the candidates. These filters may include for example, spatial, textual, semantic etc. filters that filter out entities that are not related to the query. The entities that pass the filter are deemed candidates and passed to the search controller 255 for further processing.

At act A140, the search controller 255 merges the one or more first candidates and the one or more second candidates. Different merging mechanisms may be used. In an embodiment, the primary datastore 261 and the secondary datastore 263 follow the same data model and share a common unique identifier. The identifier that is shared may be used to merge the two sets of candidates. If there is no overlap, the two candidates may be simply joined. If there is overlap, for example, either the first candidates or second candidates may be given priority and is used. In an embodiment, candidates from the secondary datastore 263 are given priority over candidates from the primary datastore 261. The secondary datastore 263 may include additional feature data or proprietary information that the organization or the user had added and thus may be useful for ranking purposes.

At act A150, the search controller 255 ranks the merged candidates based on relevancy, wherein the ranking gives priority to feature data included with the one or more second candidates. Different ranking models or algorithms may be used for the ranking. The candidates may be ranked according to a criterion so that the “best” results appear early in the result list provided to the user. The criterion may include relevancy to the semantic understanding the query, distance, rating, etc. One relevancy technique that may be used is to rank documents higher if query terms are found in “high value” fields or feature data. One example of this is to rank documents higher if query terms are found in the title of the document as opposed to someplace in the body. Typically, for ranking purposes, only a handful of features are found to be highly informative. In an embodiment, a ranking algorithm may prioritize one or more features from candidate data from the secondary datastore 263. As an example, the feature data from the secondary datastore 263 may hold some importance to the organization or user that provides the secondary datastore 263. An organization or user may thus set, use, or specify feature data in order to influence or alter the typical rank.

Different ranking mechanisms may be used. In an example, each candidate that is returned includes at least one feature (e.g. a ‘relevance_factor’) that is used by the ranker to give precedence to candidate with higher values and a second feature (distance) that is the distance from a location reference derived from the search query. Given a search query, if 2 candidates are returned: A(distance=3.14, relevance_factor=1) and B (distance=3.14, relevance_factor=2), then B is ranked first and A is ranked second because all their features except the relevance_factor are the same. If the 2 returned candidate are: A(distance=0.5, relevance_factor=1) and B (distance=3.14, relevance_factor=1), then A is ranked first, because it is closer to the user location and has the same relevance_factor as B. If the 2 returned candidate are: A(distance=0.5, relevance_factor=1) and B (distance=3.14, relevance_factor=2), then, there is not a clear determination. The ranker may learn, using machine learning to identify which candidate should be ranked first.

As an example, a user may impact the ranking by providing custom feature data. The user may be interested in pizza and provides a dataset that includes personal best pizza places ranked by the user or someone else/entity (e.g. with a customized relevance_factor value or another associated field). This data may be used to impact the ranking. As another example, an organization may provide custom feature data that scores certain POIs. Partner or associated POIs may be scored higher than competitors. Additional non-public POIs may be added to the dataset and scored highly. When performing a search using candidates from this dataset, the search controller 255 may rank these POIs higher. Organizations or users may use feature data such as custom ranks or scores to raise up their preferred results, exclude certain results, or add in additional results that otherwise might be filtered or ranked much lower.

In an embodiment, the search controller 255 may also filter the candidates prior to ranking the candidates. Filtering may be done based on the feature data provided with the candidates.

At act A160, the search controller 255 provides the ranked merged candidate data. The search controller 255 may also provide additional information with the ranked candidates. Additional information may include, for example, a rendered map, images, ratings, etc. This additional information may be stored in the geographic database 123 or in another datastore. This additional information is generally cosmetic or visual and does not factor into the search but rather provides a more detailed user interface for the search and search results.

The result of the late binding search service is an improved set of results for the search query that does not require ingestion of external data. The results or rank may be different when this additional data is provided. For example, an employee of an organization with access to certain information may thus be provided different results (ranked or filtered) from an employee of a different organization or whom otherwise did not have access to the additional data. Users and organization may be able to influence search results by providing their own datasets that include feature data that is important to the user or organization. This data may be provided to the location-based search service without having to ingest the data or otherwise store the data onsite. The ability to maintain their own data allows organizations to quickly change or update data that is important to them and their users or applications.

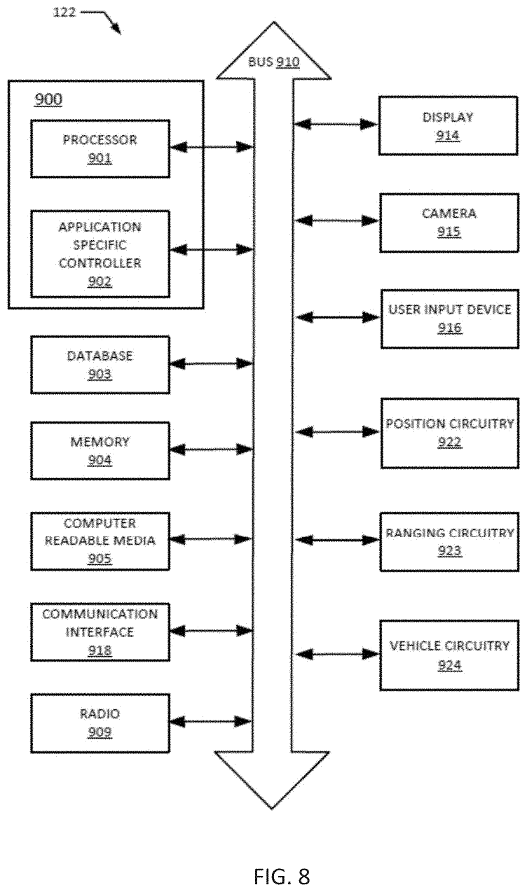

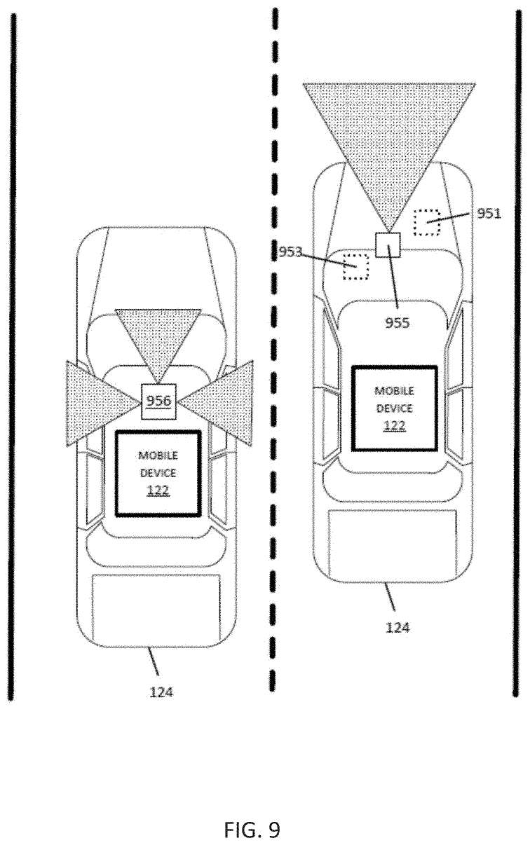

FIG. 8 illustrates an example mobile device 122 for the system of FIG. 1 that may request a location-based search from the mapping system 121. The mobile device 122 may include a bus 910 that facilitates communication between a controller 900 that may be implemented by a processor 901 and/or an application specific controller 902, which may be referred to individually or collectively as controller 900, and one or more other components including a database 903, a memory 904, a computer readable medium 905, a communication interface 918, a radio 909, a display 914, a camera 915, a user input device 916, position circuitry 922, ranging circuitry 923, and vehicle circuitry 924. The contents of the database 903 are described with respect to the geographic database 123. The device-side database 903 may be a user database that receives data in portions from the database 903 of the mobile device 122. The communication interface 918 connected to the internet and/or other networks (e.g., network 127 shown in FIG. 1). The vehicle circuitry 924 may include any of the circuitry and/or devices described with respect to FIG. 9. Additional, different, or fewer components may be included.

In an embodiment, the device 122 may be configured to store the secondary datastore 263. The secondary datastore 263 may include data that is acquired by the device 122 or a user. The secondary datastore 263 may store personal or custom data that allows searches from the device 122 to be personalized or at least include personalized data, such as custom or personal rankings or scores for points of interest.

The controller 900 may communicate with a vehicle engine control unit (ECU) that operates one or more driving mechanisms (e.g., accelerator, brakes, steering device). Alternatively, the mobile device 122 may be the vehicle ECU, that operates the one or more driving mechanisms directly.

The controller 900 may include a routing module including an application specific module or processor that calculates routing between an origin and destination. The routing module is an example means for generating a route. The routing command may be a driving instruction (e.g., turn left, go straight), that may be presented to a driver or passenger, or sent to an assisted driving system. The display 914 is an example means for displaying the routing command. The mobile device 122 may generate a routing instruction based on the anonymized data.

The routing instructions may be provided by display 914. The mobile device 122 may be configured to execute routing algorithms to determine an optimum route to travel along a road network from an origin location to a destination location in a geographic region. Using input(s) including map matching values from the server 125, a mobile device 122 examines potential routes between the origin location and the destination location to determine the optimum route. The mobile device 122, which may be referred to as a navigation device, may then provide the end user with information about the optimum route in the form of guidance that identifies the maneuvers required to be taken by the end user to travel from the origin to the destination location. Some mobile devices 122 show detailed maps on displays outlining the route, the types of maneuvers to be taken at various locations along the route, locations of certain types of features, and so on. Possible routes may be calculated based on a Dijkstra method, an A-star algorithm or search, and/or other route exploration or calculation algorithms that may be modified to take into consideration assigned cost values of the underlying road segments.

The mobile device 122 may be a personal navigation device (“PND”), a portable navigation device, a mobile phone, a personal digital assistant (“PDA”), a watch, a tablet computer, a notebook computer, and/or any other known or later developed mobile device or personal computer. The mobile device 122 may also be an automobile head unit, infotainment system, and/or any other known or later developed automotive navigation system. Non-limiting embodiments of navigation devices may also include relational database service devices, mobile phone devices, car navigation devices, and navigation devices used for air or water travel.

The radio 909 may be configured to radio frequency communication (e.g., generate, transit, and receive radio signals) for any of the wireless networks described herein including cellular networks, the family of protocols known as WIFI or IEEE 802.11, the family of protocols known as Bluetooth, or another protocol.

The memory 904 may be a volatile memory or a non-volatile memory. The memory 904 may include one or more of a read only memory (ROM), random access memory (RAM), a flash memory, an electronic erasable program read only memory (EEPROM), or other type of memory. The memory 904 may be removable from the mobile device 122, such as a secure digital (SD) memory card.

The communication interface 918 may include any operable connection. An operable connection may be one in which signals, physical communications, and/or logical communications may be sent and/or received. An operable connection may include a physical interface, an electrical interface, and/or a data interface. The communication interface 818 and/or communication interface 918 provides for wireless and/or wired communications in any now known or later developed format.

The input device 916 may be one or more buttons, keypad, keyboard, mouse, stylus pen, trackball, rocker switch, touch pad, voice recognition circuit, or other device or component for inputting data to the mobile device 122. The input device 916 and display 914 be combined as a touch screen, which may be capacitive or resistive. The display 914 may be a liquid crystal display (LCD) panel, light emitting diode (LED) screen, thin film transistor screen, or another type of display. The output interface of the display 914 may also include audio capabilities, or speakers. In an embodiment, the input device 916 may involve a device having velocity detecting abilities.

A user interface may include the input device 916 and an output device 914. The user interface may be configured to generate a query and provide results to a user. The results may be providing using data from a primary database, for example, the geographic database 123, and a secondary database that contains at least POI record that is not contained in the geographic database 123. The user interface provides a location-based query. The server 125 or mapping system 121 queries the primary datastore 261 for one or more candidates for the location-based inquiry. The server 125 or mapping system 121 identifies one or more candidates from an external datastore. The candidates are merged, filtered, and ranked. Ranking may be based on relevancy of the candidates to the location-based inquiry where feature data in the candidates from the external datastore is given priority. The ranked candidates are provided to the device 122. The output device 914 may provide a rendered view of the ranked one or more candidates to a user. The results may be used by an application in the device 122 to route or control one or more features in a vehicle or the device 122.

The ranging circuitry 923 may include a LIDAR system, a RADAR system, a structured light camera system, SONAR, or any device configured to detect the range or distance to objects from the mobile device 122.

The positioning circuitry 922 may include suitable sensing devices that measure the traveling distance, speed, direction, and so on, of the mobile device 122. The positioning system may also include a receiver and correlation chip to obtain a GPS signal. Alternatively, or additionally, the one or more detectors or sensors may include an accelerometer and/or a magnetic sensor built or embedded into or within the interior of the mobile device 122. The accelerometer is operable to detect, recognize, or measure the rate of change of translational and/or rotational movement of the mobile device 122. The magnetic sensor, or a compass, is configured to generate data indicative of a heading of the mobile device 122. Data from the accelerometer and the magnetic sensor may indicate orientation of the mobile device 122. The mobile device 122 receives location data from the positioning system. The location data indicates the location of the mobile device 122.

The positioning circuitry 922 may include a Global Positioning System (GPS), Global Navigation Satellite System (GLONASS), or a cellular or similar position sensor for providing location data. The positioning system may utilize GPS-type technology, a dead reckoning-type system, cellular location, or combinations of these or other systems. The positioning circuitry 922 may include suitable sensing devices that measure the traveling distance, speed, direction, and so on, of the mobile device 122. The positioning system may also include a receiver and correlation chip to obtain a GPS signal. The mobile device 122 receives location data from the positioning system. The location data indicates the location of the mobile device 122.

The position circuitry 922 may also include gyroscopes, accelerometers, magnetometers, or any other device for tracking or determining movement of a mobile device. The gyroscope is operable to detect, recognize, or measure the current orientation, or changes in orientation, of a mobile device. Gyroscope orientation change detection may operate as a measure of yaw, pitch, or roll of the mobile device.

FIG. 9 illustrates exemplary vehicles 124 for providing location-based services or application using the systems and methods described herein as well as collecting data for such services or applications described herein. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively, or additionally, the one or more detectors or sensors may include an accelerometer built or embedded into or within the interior of the vehicle 124. The vehicle 124 may include one or more distance data detection device or sensor, such as a LIDAR device. The distance data detection sensor may include a laser range finder that rotates a mirror directing a laser to the surroundings or vicinity of the collection vehicle on a roadway or another collection device on any type of pathway.

A connected vehicle includes a communication device and an environment sensor array for reporting the surroundings of the vehicle 124 to the server 125. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server 125. The network may be the Internet or connected to the internet.

The sensor array may include one or more sensors configured to detect surroundings of the vehicle 124. The sensor array may include multiple sensors. Example sensors include an optical distance system such as LiDAR 956, an image capture system 955 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 951 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 953, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to the lane marking indicators (lane marking type, lane marking intensity, lane marking color, lane marking offset, lane marking width, or other characteristics) received from geographic database 123 and the server 125 and driving commands or navigation commands.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) received from geographic database 123 and the server 125 and driving commands or navigation commands.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to lane marking indicators (lane marking type, lane marking intensity, lane marking color, lane marking offset, lane marking width, or other characteristics) received from geographic database 123 and the server 125 and driving commands or navigation commands.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the lane marking indicators (lane marking type, lane marking intensity, lane marking color, lane marking offset, lane marking width, or other characteristics) received from geographic database 123 and the server 125 and driving commands or navigation commands.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, may be constructed to implement one or more of the methods described herein. Applications that may include the apparatus and systems of various embodiments may broadly include a variety of electronic and computer systems. One or more embodiments described herein may implement functions using two or more specific interconnected hardware modules or devices with related control and data signals that may be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations may include distributed processing, component/object distributed processing, and parallel processing. Alternatively, virtual computer system processing may be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) may be written in any form of programming language, including compiled or interpreted languages, and it may be deployed in any form, including as a standalone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in the specification may be performed by one or more programmable processors executing one or more computer programs to perform functions by operating on input data and generating output. The processes and logic flows may also be performed by, and apparatus may also be implemented as, special purpose logic circuitry, e.g., an FPGA (field programmable gate array) or an ASIC (application specific integrated circuit).

As used in the application, the term ‘circuitry’ or ‘circuit’ refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer may be embedded in another device, e.g., a mobile telephone, a personal digital assistant (PDA), a mobile audio player, a GPS receiver, to name just a few. Computer readable media suitable for storing computer program instructions and data include all forms of non-volatile memory, media, and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The memory may be a non-transitory medium such as a ROM, RAM, flash memory, etc. The processor and the memory may be supplemented by, or incorporated in, special purpose logic circuitry.

To provide for interaction with a user, embodiments of the subject matter described in this specification may be implemented on a device having a display, e.g., a CRT (cathode ray tube) or LCD (liquid crystal display) monitor, for displaying information to the user and a keyboard and a pointing device, e.g., a mouse or a trackball, by which the user may provide input to the computer. Other kinds of devices may be used to provide for interaction with a user as well; for example, feedback provided to the user may be any form of sensory feedback, e.g., visual feedback, auditory feedback, or tactile feedback; and input from the user may be received in any form, including acoustic, speech, or tactile input.

Embodiments of the subject matter described in this specification may be implemented in a computing system that includes a back end component, e.g., as a data server, or that includes a middleware component, e.g., an application server, or that includes a front end component, e.g., a client computer having a graphical user interface or a Web browser through which a user may interact with an implementation of the subject matter described in this specification, or any combination of one or more such back end, middleware, or front end components. The components of the system may be interconnected by any form or medium of digital data communication, e.g., a communication network. Examples of communication networks include a local area network (“LAN”) and a wide area network (“WAN”), e.g., the Internet.

The computing system may include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

1. A method for late binding of external data for location-based searching, the method comprising:
receiving, by a processor, a location-based query;
searching, by the processor, a primary datastore for one or more first candidates for the location-based query;
acquiring, by the processor from a secondary datastore, one or more second candidates for the location-based query including feature data for the one or more second candidates;
merging, by the processor, the one or more first candidates and the one or more second candidates;
ranking, by the processor, the merged candidates based on relevancy to the location-based query, wherein the ranking gives priority to the feature data included with the one or more second candidates; and
providing, by the processor, the ranked merged candidates.

2. The method of claim 1, wherein the primary datastore and the secondary datastore are configured with a same data model.

3. The method of claim 1, wherein the one or more first candidates and the one or more second candidates comprise points of interest.

4. The method of claim 1, wherein the one or more second candidates include at least one candidate that is not included in the primary datastore.

5. The method of claim 1, wherein the secondary datastore comprises proprietary location related data for an organization.

6. The method of claim 5, wherein the secondary datastore is only accessible to a selected group of users.

7. The method of claim 1, wherein merging comprises prioritizing the feature data included with the one or more second candidates.

8. The method of claim 1, further comprising:
acquiring, by the processor from a tertiary datastore, one or more third candidates for the location-based query; and
merging, by the processor, the one or more first candidates, the one or more second candidates, and the one or more third candidates.

9. The method of claim 1, wherein the feature data included with the one or more second candidates is not transferred into the primary datastore.

10. The method of claim 1, wherein the feature data included with the one or more second candidates include at least a rank or a scoring metric.

11. A system for late binding of external data for location-based searching, the system comprising:
a user interface configured to receive a location-based query;
a primary datastore configured to store location related data;
at least one secondary datastore configured to store location related data comprising at least one point of interest not contained in the primary datastore;
a candidate generator configured to receive the location-based query and search the primary datastore for one or more first candidates for the location-based query; and
a search controller configured to merge the one or more first candidates with one or more second candidates acquired from the secondary datastore, the search controller further configured to rank the merged candidates and provide the ranked merged candidates to the user interface.

12. The system of claim 11, wherein the primary datastore and the secondary datastore are configured with a same data model and share a primary key unique across both the primary datastore and the secondary datastore.

13. The system of claim 11, wherein the search controller is configured to prioritize to feature data included with the one or more second candidates when ranking the merged candidates.

14. The system of claim 11, wherein the one or more first candidates and the one or more second candidates comprise points of interest.

15. The system of claim 14, wherein the one or more second candidates comprising at least one point of interest not contained in the primary datastore

16. The system of claim 11, wherein the secondary datastore is only accessible to a specified application.

17. The system of claim 11, wherein the one or more second candidates are acquired from the secondary datastore using a cloud-based lambda function.

18. An apparatus comprising:
at least one processor; and
at least one memory including computer program code for one or more programs; the at least one memory configured to store the computer program code configured to, with the at least one processor, cause the at least one processor to:
receive a location-based query;
search a primary datastore for one or more first candidates for the location-based query;
acquire from a secondary datastore one or more second candidates for the location-based query including feature data for the one or more second candidates;
merge the one or more first candidates and the one or more second candidates;
rank the merged candidates based on relevancy to the location-based query, wherein the ranking gives priority to the feature data included with the one or more second candidates; and
provide the ranked merged candidates.

19. The apparatus of claim 18, wherein the feature data included with the one or more second candidates include at least a rank or a scoring metric.

20. The apparatus of claim 18, wherein the one or more second candidates are acquired from the secondary datastore using a cloud-based lambda function.
